(19) United States
(12) Patent Application Publication
(10) Pub. No.: US 2011/0242007 A1
(43) Pub. Date: Oct. 6, 2011

(54) E-Book with User-Manipulatable Graphical Objects

(76) Inventors: Theodore W. Gray, Champaign, IL (US); Max Whitby, London (GB)

(21) Appl. No.: 12/753,024

(22) Filed: Apr. 1, 2010

(51) Int. Cl. G06F 3/041

(52) U.S. Cl. 345/173

(57) ABSTRACT

A method and apparatus of providing graphics in an e-book page includes displaying an e-book page of an e-book on a display, wherein the e-book page includes an embedded moving image object, receiving a multi-touch user input via a multi-touch touchscreen associated with the display, wherein the multi-touch user input corresponds to a user input command to animate the moving image object, and animating the moving image object in place in the e-book page in response to the multi-touch user input. The embedded moving object may be one of a plurality of embedded moving image objects included in the e-book page and the method and apparatus may receive a plurality of multi-touch user inputs via the multi-touch touchscreen associated with the display, with each multi-touch user input corresponding to a respective user input command to animate a respective moving image object. The method and apparatus may then animate each of the plurality of moving image objects in place in the e-book page in response to the plurality of multi-touch user inputs.

### FIELD OF THE DISCLOSURE

The present disclosure relates generally to electronic books (e-books) and, more particularly, to e-books having user-manipulatable graphical objects embedded in e-book pages.

### BACKGROUND

Electronic book readers (e-book readers) are, in many instances, generally implemented on computing devices that are designed primarily for the purpose of reading digital books (e-books) and periodicals. Many e-book readers utilize electronic paper display (EPD) technology, which show text in a way that appears much like text printed on paper. However, these EPD displays are not very capable of displaying graphics, pictures, etc., as compared to standard computer displays, and thus are not very adept at displaying complex graphics in the context of e-book pages. As a result, these EPD devices are not generally suitable for implementing rotating and user manipulable graphics as part of a display.

Personal computers and the like are widely used to read text documents and view web pages. However, these computer displays are not generally configured or used for e-book reading purposes, or to display complex graphics with multi-touch interactivity. While some computer platforms, such as the Apple® iPad, use a conventional LCD backlit screen which is good for reading and viewing for long periods of time, complex and interactive graphics that can be used in e-book contexts remain relatively undeveloped.

### SUMMARY

A method of presenting graphics in an e-book page includes displaying an e-book page of an e-book on a display, wherein the e-book page includes an embedded moving image object, receiving a single touch or a multi-touch user input via a multi-touch touchscreen associated with the display, wherein the user input corresponds to a user input command to animate the moving image object, and animating the moving image object in place in the e-book page in response to the multi-touch user input. In one embodiment, the embedded moving object is one of a plurality of embedded moving image objects included in the e-book page and the method may include receiving a plurality of multi-touch user inputs via the multi-touch touchscreen associated with the display, with each multi-touch user input corresponding to a respective user input command to animate a respective moving image object and animating each of the plurality of moving image objects in place in the e-book page in response to the plurality of multi-touch user inputs.

If desired, at least two of the plurality of multi-touch user inputs may be received simultaneously, and the method may start animating at least two of the plurality of moving image objects simultaneously in response to the at least two of the plurality of multi-touch user inputs. Likewise, the method may animate each of the plurality of moving image objects at the same time.

Moreover, the embedded moving image object may have a transparent background that overlaps with at least one other object displayed on the e-book page, which other object may be a text block. Here, the transparent background of the embedded moving image object may overlap with a non-transparent portion of the text block. If desired, the other object may include another embedded moving image object and the transparent background of the embedded moving image object may overlap with a non-transparent or a transparent background portion of the another embedded moving image object.

### BRIEF DESCRIPTION OF THE DRAWINGS

FIG. 1 a block diagram of an example computing device having a multi-touch touchscreen;

FIGS. 2A and 2B are illustrations of an example e-book page with user manipulatable graphical objects embedded in the page;

FIGS. 3A-3D are illustrations of another example e-book page with a user manipulatable graphical object embedded in the page;

FIG. 4 is an illustration of another example e-book page with a user manipulatable graphical object embedded in the page;

FIG. 5 is an illustration of another example e-book page with a user manipulatable graphical object embedded in the page;

FIG. 6 is an illustration of a user manipulatable stereoscopic image of the sun;

FIG. 7 is a flow diagram of an example method for displaying an e-book page having user manipulatable embedded moving image objects; and

FIG. 8 is a flow diagram of an example method for transmitting an e-book to a computing device such as an e-book reader.

### DETAILED DESCRIPTION

In some embodiments described below, an electronic book (e-book) includes e-book pages in which moving image objects are embedded. As used herein, the term “moving image object” means a graphical image that changes over time. Examples of moving image objects include a depiction of a physical or computer generated three-dimensional (3D) object spinning on an axis, a depiction of a physical or computer generated 3D object tumbling in space, a depiction of a physical or computer generated 3D object being viewed from a viewpoint that is changing over time, a depiction of a physical or computer generated 3D object or process or scene whose appearance changes over time, a video, an animation, etc.

The moving image objects are user manipulatable by way of a user input device such as a multi-touch touchscreen, a touch pad, a mouse, etc. For example, a user can animate a moving image object with a user input such as a touch, a swipe, a click, a drag, etc. As used herein, the term “animate a moving image object” means to cause the moving image object to go through a series of changes in appearance. For example, a user may “swipe” or “throw” an image of a physical object and cause the physical object to spin, on an axis (i.e., a series of images of the physical object are displayed over time, resulting in a depiction of the object spinning). As another example, a user may “swipe” a frozen video image and cause the video to play.

In some embodiments, a moving image object embedded in an e-book page can be animated in place. For example, a user may “swipe” an image of a physical object embedded in an e-book page and cause the physical object to spin or tumble in place in the e-book page. This is in contrast, for example, to a window separate from an e-book page that is opened and that permits a user to view the object spinning or tumbling in the separate window. In some embodiments, a layout of an e-book page is composed by an editor, and a user can view an animated moving image object in place in the e-book page and thus in the context of the layout composed by the editor.

As used herein, the term “e-book” refers to a composed, packaged, set of content, stored in one or more files, that includes text and graphs. The e-book content is arranged in pages, each page having a layout corresponding to a desired spatial arrangement of text and images on a two dimensional (2D) display area. Generally, the content of an e-book is tied together thematically to form a coherent whole. Examples of an e-book include a novel, a short story, a set of short stories, a book of poems, a non-fiction book, an educational text book, a reference book such as an encyclopedia, etc.

In an embodiment, an e-book includes a linearly ordered set of pages having a first page and a last page. In some embodiments in which pages are in a linear order, a user can view pages out of order. For example, a user can specify a particular page (e.g., by page number) to which to skip or return and thus go from one page to another out of the specified order (e.g., go from page 10 to page 50, or go from page 50 to page 10). In other embodiments, the pages of an e-book are not linearly ordered. For example, the e-book pages could be organized in a tree structure.

In some embodiments, a user can cause a plurality of moving image objects embedded in an e-book page to be animated simultaneously. For example, a user can serially animate the plurality of moving image objects so that, eventually, all of the moving image objects are animated at the same time.

In some embodiments, the e-book is configured to be viewed with a device with a multi-touch touchscreen. For example, the device may be a mobile computing device such as an e-book reader, a tablet computer, a smart phone, a media player, a personal digital assistant (PDA), an Apple® iPod, etc. In some embodiments that utilize a device with a multi-touch touchscreen, a user can simultaneously animate a plurality of moving image objects that are displayed on a display. For example, the user can touch or swipe at the same time, with several finger tips, the plurality of moving image objects thus causing the plurality moving image objects to become animated at the same time.

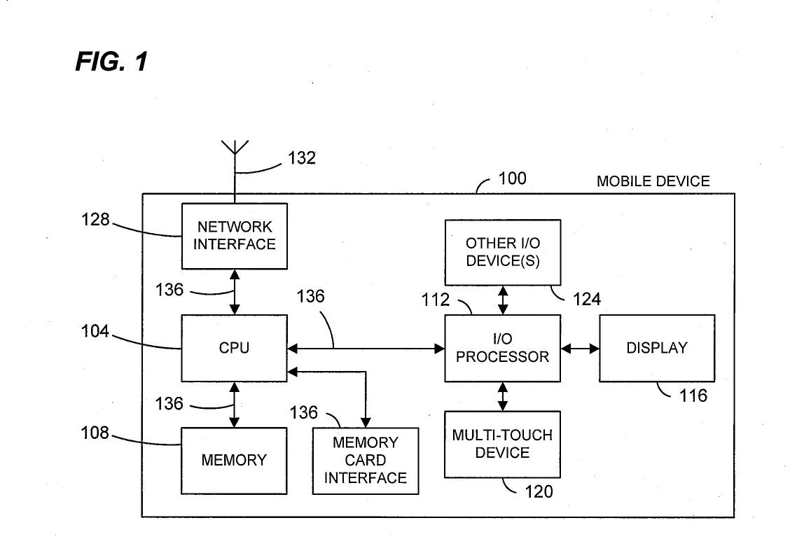

FIG. 1 is a block diagram of an example mobile computing device 100 that can used to view and interact with e-books such as described herein, according to an embodiment. The device 100 includes a central processing unit (CPU) 104 coupled to a memory 108 (which can include one or more computer readable storage media such as random access memory (RAM), read only memory (ROM), FLASH memory, a hard disk drive, a digital versatile disk (DVD) disk drive, a Blu-ray disk drive, etc.). The device also includes an input/output (I/O) processor 112 that interfaces the CPU 104 with a display device 116 and a multi-touch touch-sensitive device (or multi-touch touchscreen) 120. The I/O processor 112 also interfaces one or more additional I/O devices 124 to the CPU 104, such as one or more buttons, click wheels, a keypad, a touch pad, another touchscreen (single-touch or multi-touch), lights, a speaker, a microphone, etc.

A network interface 128 is coupled to the CPU 104 and to an antenna 132. A memory card interface 136 is coupled to the CPU 104. The memory card interface 136 is adapted to receive a memory card such as a secure digital (SD) card, a miniSD card, a microSD card, a Secure Digital High Capacity (SDHC) card, etc., or any suitable card.

The CPU 104, the memory 108, the I/O processor 112, the network interface 128, and the memory card interface 136 are coupled to one or more busses 136. For example, the CPU 104, the memory 108, the I/O processor 112, the network interface 128, and the memory card interface 136 are coupled to a single bus 136, in an embodiment. In another embodiment, the CPU 104 and the memory 108 are coupled to a first bus, and the CPU 104, the I/O processor 112, the network interface 128, and the memory card interface 136 are coupled to a second bus.

The device 100 is only one example of a mobile computing device 100, and other suitable devices can have more or fewer components than shown, can combine two or more components, or a can have a different configuration or arrangement of the components. The various components shown in FIG. 1 can be implemented in hardware, software or a combination of both hardware and software, including one or more signal processing and/or application specific integrated circuits.

The CPU 104 executes computer readable instructions stored in the memory 108. The I/O processor 112 interfaces the CPU 104 with input and/or output devices, such as the display 116, the multi-touch touch screen 120, and other input/control devices 124. The I/O processor 112 can include a display controller (not shown) and a multi-touch touchscreen controller (not shown). The multi-touch touchscreen 120 includes one or more of a touch-sensitive surface and a sensor or set of sensors that accepts input from the user based on haptic and/or tactile contact. The multi-touch touchscreen 120 utilizes one or more of currently known or later developed touch sensing technologies, including one or more of capacitive, resistive, infrared, and surface acoustic wave technologies, as well as other proximity sensor arrays or other elements for determining one or more points of contact with the multi-touch touchscreen 120. The multi-touch touchscreen 120 and the I/O processor 112 (along with any associated modules and/or sets of instructions stored in memory 102 and executed by the CPU 104) can detect multiple points of or instances of simultaneous contact (and any movement or breaking of the contact(s)) on the multi-touch touchscreen 120. Such detected contact can be converted by the CPU 104 into interaction with user-interface or user-manipulatable objects that are displayed on the display 116. A user can make contact with the multi-touch touchscreen 120 using any suitable object or appendage, such as a stylus, a finger, etc.

The network interface 128 facilitates communication with a wireless communication network such as a wireless local area network (WLAN), a wide area network (WAN), a personal area network (PAN), etc., via the antenna 132. In other embodiments, one or more different and/or additional network interfaces facilitate wired communication with one or more of a local area network (LAN), a WAN, another computing device such as a personal computer, a server, etc.

Software components (i.e., sets of computer readable instructions executable by the CPU 104) are stored in the memory 108. The software components can include an operating system, a communication module, a contact module, a graphics module, and applications such as an e-book reader application. The operating system can include various software components and/or drivers for controlling and managing general system tasks (e.g., memory management, etc.) and can facilitate communication between various hardware and software components. The communication module can facilitate communication with other devices via the network interface 128.

The contact module can detect contact with multi-touch touchscreen 120 (in conjunction with the I/O processor 112). The contact module can include various software components for performing various operations related to detection of contact, such as determining if contact has occurred, determining if there is movement of the contact and tracking the movement across the multi-touch touchscreen 120, and determining if the contact has been broken (i.e., if the contact has ceased). Determining movement of the point of contact can include determining speed (magnitude), velocity (magnitude and direction), and/or an acceleration (a change in magnitude and/or direction) of the point of contact. These operations can be applied to single contacts (e.g., one finger contacts) or to multiple simultaneous contacts (e.g., “multi-touch”/multiple finger contacts).

The graphics module can include various suitable software components for rendering and displaying graphics objects on the display 116. As used herein, the term “graphics” includes any object that can be displayed to a user, including without limitation text, web pages, icons (such as user-interface objects including soft keys), e-book pages, digital images, videos, animations and the like. An animation in this context is a display of a sequence of images that gives the appearance of movement, and informs the user of an action that has been performed (such as moving an icon to a folder).

In an embodiment, the e-book reader application is configured to display e-book pages on the display 116 with embedded moving image objects and to display animated moving image objects in place in the e-book pages on the display 116. Additionally, in an embodiment, the e-book reader application is configured to animate moving image objects on the display 116 in response to user input via the multi-touch touchscreen 120. The e-book reader application may be loaded into the memory 108 by a manufacturer of the device 100, by a user via the network interface 128, by a user via the memory card interface 136, etc. In one embodiment, the e-book reader application is integrated with an e-book having e-book pages with embedded moving image objects. For example, if a user purchases the e-book, the e-book is provided with an integrated e-book reader application to permit viewing and interacting with the e-book and the embedded moving image objects. In another embodiment, the e-book reader application is separate from e-books that it is configured to display and, for example, can be utilized to view a plurality of different e-books.

Each of the above identified modules and applications can correspond to a set of instructions for performing one or more functions described above. These modules need not be implemented as separate software programs, procedures or modules, and thus various subsets of these modules can be combined or otherwise re-arranged in various embodiments. In some embodiments, the memory 108 stores a subset of the modules and data structures identified above. In other embodiments, the memory 108 stores additional modules and data structures not described above.

In an embodiment, the device 100 is an e-book reader device or a device that is capable of functioning as an e-book reader device. As will be described in more detail below, an e-book is loaded to the device 100 (e.g., loaded to the memory 108 via the network interface 128, loaded by insertion of a memory card into the memory card interface 136, etc.), wherein the e-book includes moving image objects that are manipulatable by the user and that are embedded in pages of the e-book.

In various examples and embodiments described below, e-book pages are described with reference to the device 100 of FIG. 1 for ease of explanation. In other embodiments, another suitable device different than the device 100 is utilized to display e-book pages and to permit a user to manipulate moving image objects embedded in pages of the e-book.

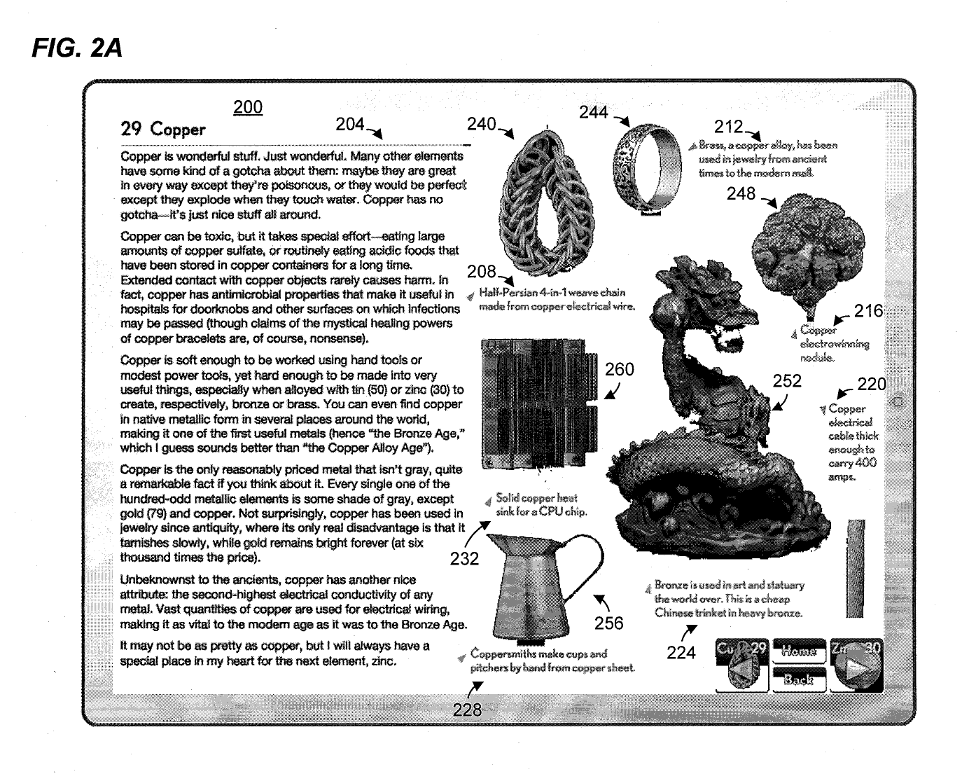

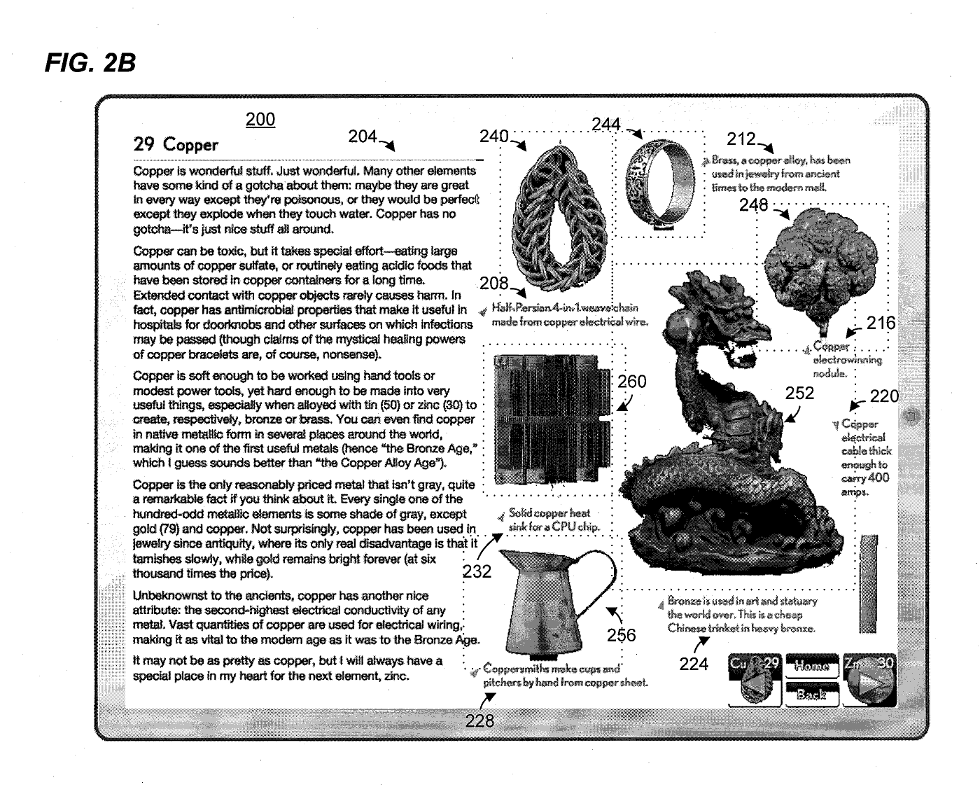

FIG. 2A is an example e-book page 200 displayed on the display 116. The page 200 includes a plurality of text blocks 204, 208, 212, 216, 220, 224, 228, 232 and a plurality of moving image objects 240, 244, 248, 252, 256, 260 arranged in a desired layout on the page 200. Each of the moving image objects 240, 244, 248, 252, 256, 260 depicts a corresponding physical object, and can be animated in response to touch input via the multi-touch touchscreen 120. In an embodiment, each of the moving image objects 240, 244, 248, 252, 256, 260, when animated, depicts the corresponding physical object spinning on an axis, such as a vertical axis roughly through a center of gravity of the physical object, for example. In an embodiment, a “swipe” input by the user on the moving image object causes the moving image object to start animating (e.g., spinning), and the object may continue to spin until the user stops the movement by touching the object, for example. In another embodiment, the spin or tumble of the object may slow down on its own, as if by friction obeying the laws of physics, over the course of 5-20 seconds, depending on how fast the user “threw” or moved the object initially. In this case, the object may always end up back in its preferred orientation, designed to show off the object from its best angle and also to make the page as a whole look beautifully composed as an integral unit. In another embodiment, a moving image object only spins in one direction when animated while in still other embodiments, the moving image object may spin in multiple directions depending on the touch input of the user. For example, a swipe in a first direction causes the object to spin in a first direction, and a swipe in a second direction causes the object to spin in a second direction. For example, if the user swipes from left to right, the physical object spins in a first direction; and if the user swipes from right to left, the physical object spins in a second direction that is opposite to the first direction. In an embodiment, pressing on a first portion of the object causes the object to spin a first direction, while pressing on a second portion of the object causes the object to spin a second direction. When the user's finger is removed, the object may stop spinning. When a moving image object is animated, it depicts the physical object spinning in smooth, fluid motion, in an embodiment, such that the motion of the physical object appears natural and life-like (i.e., substantially without noticeable jerks).

In still a further embodiment, the object may track the user's finger or other movement, so that the object rotates proportionally in response to finger movement. In this mode, if the user presses and holds the object in one spot, nothing happens. However, if the user then moves his or her finger left and/or right while continuing to hold down on the object, the object follows the user's finger or other movement, rotating in direct proportion to how far the user moved his or her finger. Here, the object may return to the same or original position if the user moves his or her finger back to where it started. The “gearing” ratio between finger movement and degree of rotation may be calculated based on the physical size of the object on the screen so that, to a first approximation, a spot on the front surface of the object will roughly follow the position of the user's finger, at least until the user's finger leaves the area of the object. However, other gearing ratios may be used instead.

As seen in FIG. 2A, the moving image objects 240, 244, 248, 252, 256, 260 are embedded in the page 200. In an embodiment, when each moving image objects 240, 244, 248, 252, 256, 260 is animated, the animation occurs in place in the page 200. Additionally, in one embodiment, a user can cause at least two of moving image objects 240, 244, 248, 252, 256, 260 to become animated at substantially the same time. For example, if the user touches or swipes at least two of moving image objects 240, 244, 248, 252, 256, 260 at substantially the same time (e.g., by touching with multiple fingertips), the touched moving image objects will start animating at the substantially the same time. In another embodiment, a user can animate at least two of moving image objects 240, 244, 248, 252, 256, 260 by touching or swiping moving image objects at separate times, so that that at least two of moving image objects 240, 244, 248, 252, 256, 260. For example, the user could swipe the moving image object 248, causing it to spin. Then, while the object 248 is still spinning, the user could swipe the moving image object 252, causing it to spin as well. In this or a similar manner, the user can cause at least two of moving image objects 240, 244, 248, 252, 256, 260 to be animated at the same time.

In one embodiment, when the page 200 is initially displayed on the display 116, the moving image objects 240, 244, 248, 252, 256, 260 are animated for a period of time and then stopped, without intervention by the user. In this manner, it is signaled to the user that the moving image objects 240, 244, 248, 252, 256, 260 are manipulatable and can be animated. In this embodiment, the moving image objects 240, 244, 248, 252, 256, 260 can begin animation at the same time or at different times. Similarly, the moving image objects 240, 244, 248, 252, 256, 260 can stop animation at the same time or at different times. The moving image objects 240, 244, 248, 252, 256, 260 can all be animated for the same period of time or for different periods of time.

In one embodiment, each moving image object 240, 244, 248, 252, 256, 260 has a rectangular shape that, in the example page 200 of FIG. 2A, is not visible to the user. For example, portions of each moving image object 240, 244, 248, 252, 256, 260, in the example page 200 of FIG. 2A, are transparent and thus not visible to the user. FIG. 2B is an illustration of the example e-book page 200 of FIG. 2A, but showing indications of the rectangular shapes of the moving image objects 240, 244, 248, 252, 256, 260. As used herein, the term “rectangular” encompasses a square shape. In other words, a square is a “rectangle”, as that term is used herein.

In other embodiments, one or more of the moving image objects 240, 244, 248, 252, 256, 260 may have a shape other than a rectangular shape. However, a rectangle can be defined that fully, but minimally, encompasses the moving image object. For example, a rectangle corresponding to the sides of the page 200 fully encompasses the object 256, but does not do so minimally. Similarly, a rectangle having a side that passes through any portion of an image of a physical object (at any point in the animation) does not fully encompass the moving image object. For example, with respect to the moving picture object 256 (depicting a physical object—a pitcher), a rectangle that fully encompasses the moving picture object 256 must extend to the left of the pitcher shown in FIG. 2B so that, when the pitcher spins about a vertical axis through a center of gravity of the pitcher and the handle of the pitcher extends to the left, the handle is still encompassed by the rectangle. In an embodiment, the vertical sides of all of the encompassing rectangular shapes are parallel with each other, and the horizontal sides are parallel with each other. In an embodiment, the vertical sides of all of the encompassing rectangular shapes are parallel to the vertical sides of the page 200, and the horizontal sides of all of the encompassing rectangular shapes are parallel to the horizontal sides of the page 200.

However, for the purposes of determining which object has been touched, techniques besides simply determining which rectangular abounding box is touched may need to be used because multiple bounding rectangles often heavily overlap, to the point that some objects could be impossible to hit if they are entirely within the field of a larger object. In one embodiment, the system may apply a logic rule such that when a user touches an area or location belonging to more than one object (that is, a location encompassed by more than one object rectangle or object box), the user is deemed to have selected (hit or touched) the object box having a center point closest to the touch point. Thus, this technique preferably detects which of the multiple objects to animate by detecting which of the minimal bounding rectangles includes a center point closest to a first touch event of the multi-touch user input. Of course, if desired, touch events of the multi-touch user input other than the first touch event could be used to determine which object is being selected or animated by the user. In any event, the effect of this technique is that, where two object boxes meet, a diagonal line spitting the area overlapped by both of them exists (with the line being perpendicular to a line drawn between the two center points of the object boxes). The object box that is selected is then based on a detection of which side of this diagonal line the touch event occurs. Technically, this technique forms a Voronoi diagram, when determining which box or object is selected.

Similar to the objects described above, each text block 204, 208, 212, 216, 220, 224, 228, 232 may also have a rectangular shape that, in the example page 200 of FIGS. 2A and 2B, is not visible to the user. Thus, although not depicted in FIG. 2B, the text blocks 204, 208, 212, 216, 220, 224, 228, 232 may have rectangular shapes and may be handled similar to objects.

In the example of FIG. 2B, some of the moving image objects 240, 244, 248, 252, 256, 260 (having rectangular shapes) overlap with others of the moving image objects 240, 244, 248, 252, 256, 260 and/or the text blocks 204, 208, 212, 216, 220, 224, 228, 232. For example, the object 252 overlaps with the objects 248, 256, 260 and the text blocks 208, 216, 220. As another example, the object 256 overlaps with the text block 204. Additionally, when the pitcher spins and the handle of the pitcher extends to the left, the handle itself will overlap with a rectangular shape that fully and minimally encompasses the text block 204.

The overlapping of and/or by the moving image objects 240, 244, 248, 252, 256, 260 permits flexibility in the layout of the page 200 and, in particular, the arrangement of the text blocks 204, 208, 212, 216, 220, 224, 228, 232 and the moving image objects 240, 244, 248, 252, 256, 260 on the page 200.

In an embodiment, one or more of the moving image objects 240, 244, 248, 252, 256, 260 are implemented as a video in which a series of images, when displayed in succession and for short durations, depict the physical object moving in a desired manner (e.g., spinning on a vertical, horizontal, or some other axis, tumbling etc.). In such embodiments, the background of the video is set as transparent. In an embodiment, the background is set as transparent using an alpha channel technique. Thus, in an embodiment, a display controller of the I/O processor 112 is configured to handle graphics data with alpha channel information indicating a level of transparency.

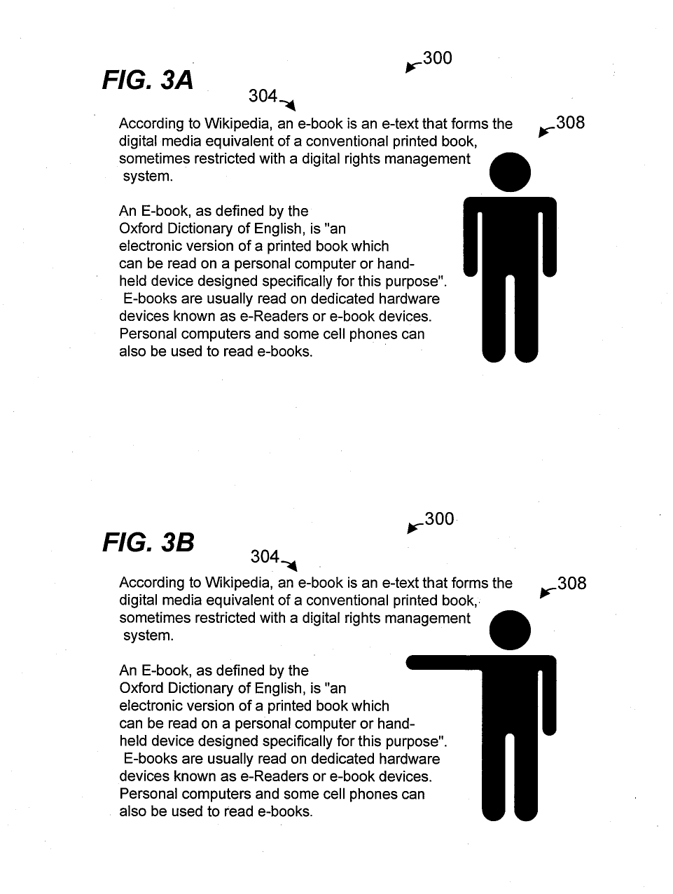

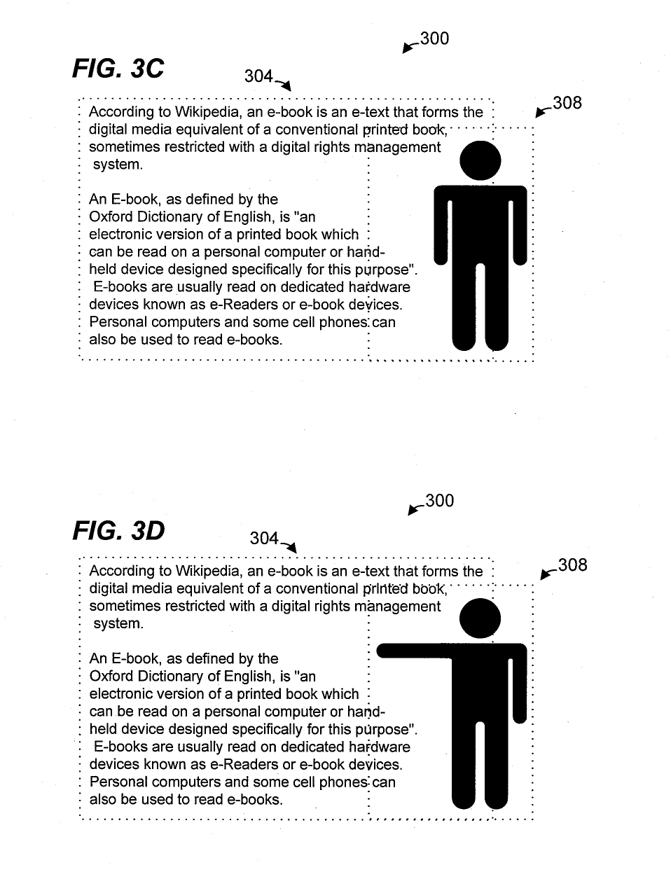

FIGS. 3A, 3B, 3C, 3D are illustrations of another e-book page 300. The e-book page 300 includes a text block 304 and a moving image object 308. In the example of FIGS. 3A-3D, the moving image object 308 is a video of a person 312 moving their right arm up and down. For example, in FIG. 3A, the arm is down, whereas in FIG. 3B, the arm is up. In an embodiment, a person can animate the video 308 by touching or swiping at a location corresponding to the person 312. In response, the video 308 begins playing in which the person 312 moves their right arm up and down.

FIGS. 3C and 3D indicate the rectangular shapes of the text block 304 and the video 308. In an embodiment, at least some of the background of the video is transparent. For example, in an embodiment, at least the portion of the background of the video 308 that overlaps with the rectangle corresponding to the text block 304 is transparent. In another embodiment, at least the portion of the background of the video 308 that overlaps with text in the text block 304 is transparent.

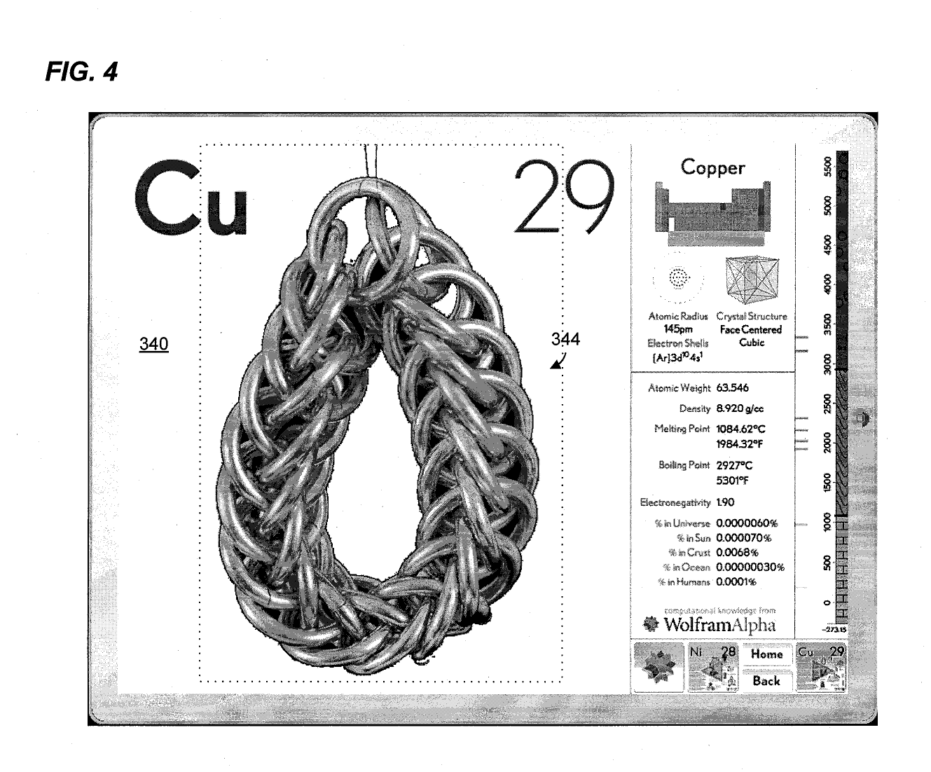

Of course, an e-book will have multiple pages. Some or all of the e-book pages can have embedded moving image objects such as described above. For example, FIG. 4 illustrates an example e-book page 340 having an embedded moving image object 344. A user can cause the object 344 to spin using touch inputs, as described above. The extent of the object 344 is indicated by a rectangle. As can be seen, the object 344 overlaps with text blocks. In particular, a transparent portion of the background 344 overlaps with text blocks.

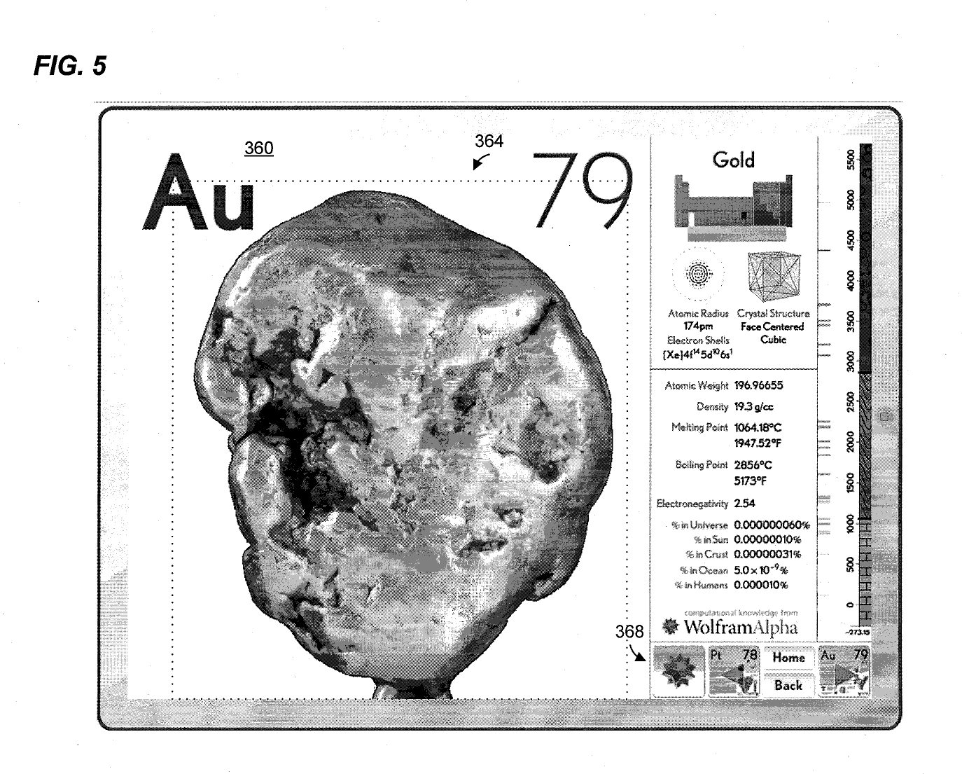

FIG. 5 illustrates an example e-book page 360 having an embedded moving image object 364. A user can cause the object 364 to spin using touch inputs, as described above. The extent of the object 364 is indicated by a rectangle. As can be seen, the object 364 overlaps with text blocks. In particular, a transparent portion of the background 364 overlaps with text blocks.

In another aspect, the e-book reader application is configured to retrieve data via the network interface 128 and via a communications network in response to user inputs. As an example, a user can press a button on an e-book page and view current information (obtained via the network interface 128 and via a communications network, and in response to the button press) regarding a subject associated with the e-book page. In one embodiment, the information includes information that changes relatively rapidly, such as monthly, daily, hourly, etc., in at least some scenarios. In one embodiment, the information is provided by a natural language answer system such as described in U.S. patent application Ser. No. 11/852,044, entitled “Methods and Systems for Determining a Formula,” filed Sep. 7, 2007, which is hereby incorporated by reference herein in its entirety.

Referring to FIG. 5, the example page 360 includes a button 368 which when pressed by a user, the e-book reader application, in response, causes the network interface 128 to transmit, via a communications network, a natural language query to a natural language answer system such as described in U.S. patent application Ser. No. 11/852,044. Then, the device 100 receives information in response to the query via the network interface 128, and the e-book reader application displays the information on the display 116, in a window separate from the e-book page, for example.

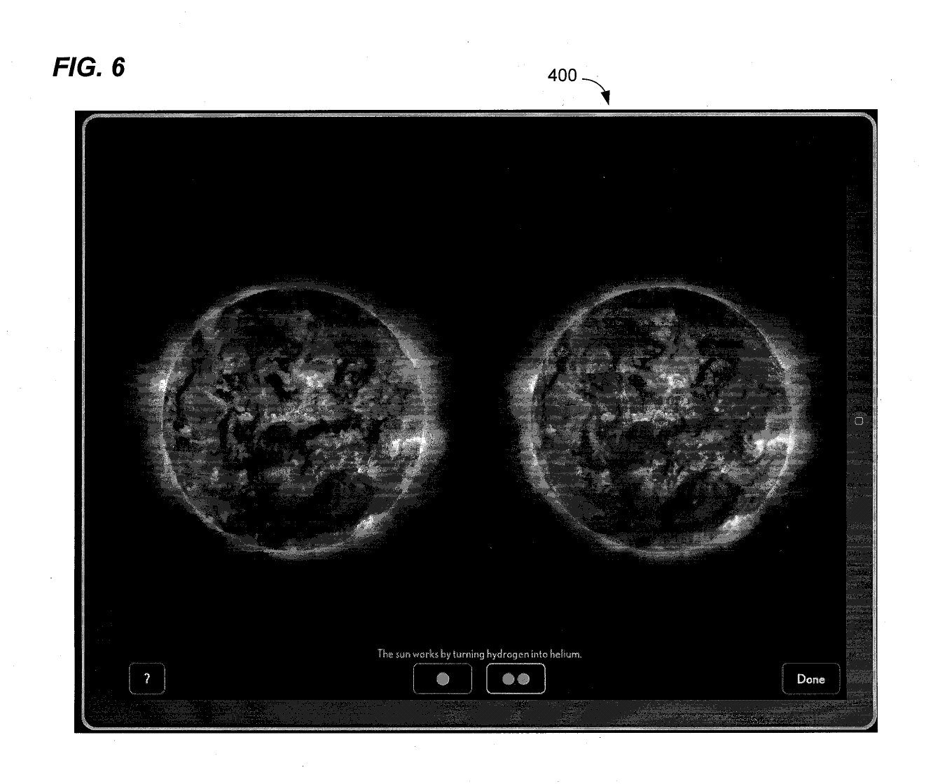

In another aspect, a user can view a 3D animation of a moving image object. For example, a user can select a moving image object embedded in a page and, in response, a separate window is displayed on the display 116 that depicts a 3D animation of the moving image object. FIG. 6 illustrates a window with a stereoscopic depiction of the sun. The depiction can be animated so that the sun rotates on a vertical axis. If a user wears suitable eye gear (e.g., stereoscopic glasses), the depiction appears to the user as a 3D spinning object.

Although FIGS. 2A, 2B, 4, 5, and 6 illustrate examples having moving image objects that depict physical objects spinning on an axis, other e-book pages can include other types of moving image objects such as objects that depict physical objects that tumble, a depiction of a physical or computer generated 3D object being viewed from a viewpoint that is changing over time, a depiction of a physical or computer generated 3D object or process or scene whose appearance changes over time, a video, an animation, etc.

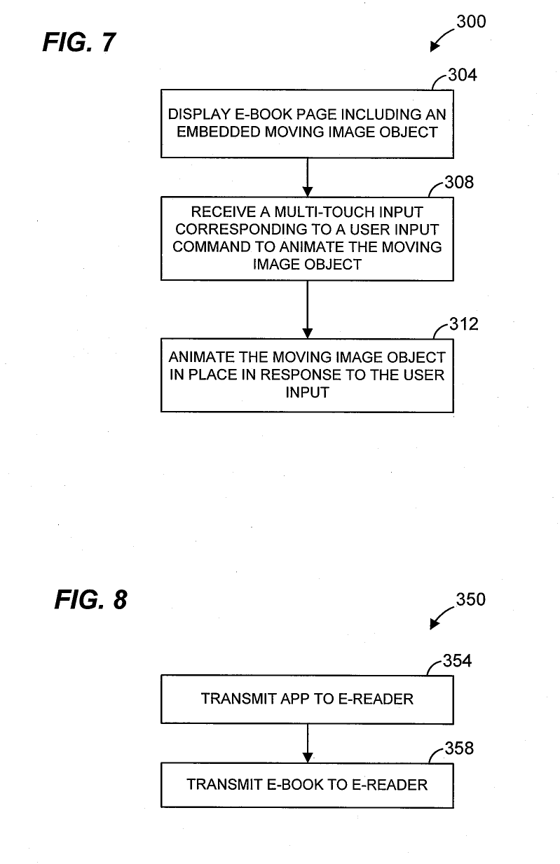

In another aspect, FIG. 7 is a flow diagram of an example method 500 for displaying an e-book page having user manipulatable embedded moving image objects, according to an embodiment. At block 504, an e-book page of an e-book is displayed on a display, wherein the e-book page includes at least one embedded moving image object. At block 508, a multi-touch user input via a multi-touch touchscreen associated with the display is received. The multi-touch user input corresponds to a user input command to animate the moving image object. At block 512, the moving image object is animated in place in the e-book page in response to the multi-touch user input.

In another aspect, FIG. 8 is a flow diagram of an example method 550 for transmitting an e-book to a computing device such as an e-book reader. At block 554, an e-book reader application is transmitted to the computing device via a communications network, such as the Internet. The e-book reader application can be configured as described above. At block 558, an e-book is transmitted to the computing device via the communications network. The e-book includes embedded moving image objects such as described above, and the e-book reader is capable of displaying the embedded moving image objects and allowing a user to manipulate the embedded moving image objects such as described above. In one embodiment, the e-book reader and the e-book are integrated together.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. Likewise, the software or firmware instructions may be delivered to a user or a system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software or firmware instructions may be delivered to a user or a system via a communication channel such as a telephone line, a DSL line, a cable television line, a fiber optics line, a wireless communication channel, the Internet, etc. (which are viewed as being the same as or interchangeable with providing such software via a transportable storage medium). The software or firmware instructions may include machine readable instructions that, when executed by the processor, cause the processor to perform various acts.

When implemented in hardware, the hardware may comprise one or more of discrete components, an integrated circuit, an application-specific integrated circuit (ASIC), etc.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

What is claimed is:

1. A method, comprising:
displaying an e-book page of an e-book on a display, wherein the e-book page includes an embedded moving image object;
receiving a multi-touch user input via a multi-touch touchscreen associated with the display, wherein the multi-touch user input corresponds to a user input command to animate the moving image object; and
animating the moving image object in place in the e-book page in response to the multi-touch user input.

2. A method according to claim 1, wherein the embedded moving object is one of a plurality of embedded moving image objects included in the e-book page;
wherein the method comprises:
receiving a plurality of multi-touch user inputs via the multi-touch touchscreen associated with the display, wherein each multi-touch user input corresponds to a respective user input command to animate a respective moving image object; and
animating each of the plurality of moving image objects in place in the e-book page in response to the plurality of multi-touch user inputs.

3. A method according to claim 2, wherein at least two of the plurality of multi-touch user inputs are received simultaneously;
wherein the method includes starting animation of at least two of the plurality of moving image objects simultaneously in response to the at least two of the plurality of multi-touch user inputs received simultaneously.

4. A method according to claim 2, comprising animating each of the plurality of moving image objects at the same time.

5. A method according to claim 1, wherein the embedded moving image object has a transparent background that overlaps with at least one other object displayed on the e-book page.

6. A method according to claim 5, wherein the at least one other object includes a text block.

7. A method according to claim 6, wherein the transparent background of the embedded moving image object overlaps with a non-transparent portion of the text block.

8. A method according to claim 5, wherein the at least one other object includes another embedded moving image object.

9. A method according to claim 8, wherein the transparent background of the embedded moving image object overlaps with a non-transparent portion of the another embedded moving image object.

10. A method according to claim 8, wherein the transparent background of the embedded moving image object overlaps with a transparent background of the another embedded moving image object.

11. A method according to claim 1, wherein animating the moving image object in place in the e-book page includes causing the image object to appear to spin in place in response to the multi-touch user input.

12. The method according to claim 11, further including causing the image object to spin at a decreasing rate for a period of time after the occurrence of the multi-touch user input until the image object comes to rest.

13. The method according to claim 12, wherein the image object comes to rest at a predefined graphical orientation.

14. The method according to claim 12, wherein the period of time or an initial rate of spin of the image object is determined by a characteristic of the multi-touch user input.

15. The method according to claim 1, wherein animating the moving image object in place in the e-book page includes causing the image object to appear to track a movement of a user based on one or more characteristics of the multi-touch user input.

16. The method of claim 1, wherein the e-book page includes multiple embedded moving image objects and including detecting which of the multiple moving image objects to animate based on the multi-touch user input, including detecting which of the multiple moving image objects has a center point closest to one of the touches of the multi-touch user input.

17. The method of claim 16, further including defining a minimal bounding rectangle for each of the multiple moving image objects and detecting which of the multiple moving image objects to animate by detecting which of the minimal bounding rectangles includes a center point closest to a first touch event of the multi-touch user input.

18. A computer readable storage medium or media having stored thereon machine readable instructions that, when executed by a processor, cause the processor to:
cause an e-book page of an e-book to be displayed on a display coupled to the processor, wherein the e-book page includes an embedded moving image object; and
cause the moving image object to be animated in place in the e-book page in response to a multi-touch user input received via a multi-touch touchscreen associated with the display, wherein the multi-touch user input corresponds to a user input command to animate the moving image object.

19. A computer readable storage medium or media according to claim 18, wherein the embedded moving object is one of a plurality of embedded moving image objects included in the e-book page;
wherein the computer readable storage medium or media has stored thereon machine readable instructions that, when executed by a processor, cause the processor to:
cause each of the plurality of moving image objects to be animated in place in the e-book page in response to a plurality of multi-touch user inputs received via the multi-touch touchscreen associated with the display, wherein each multi-touch user input corresponds to a respective user input command to animate a respective moving image object.

20. A computer readable storage medium or media according to claim 19, wherein at least two of the plurality of multi-touch user inputs are received simultaneously;
wherein the computer readable storage medium or media has stored thereon machine readable instructions that, when executed by a processor, cause the processor to:
cause animation of at least two of the plurality of moving image objects to start simultaneously in response to the at least two of the plurality of multi-touch user inputs received simultaneously.

21. A computer readable storage medium or media according to claim 20, having stored thereon machine readable instructions that, when executed by a processor, cause the processor to:
cause each of the plurality of moving image objects to be animated at the same time.

22. A computer readable storage medium or media according to claim 18, wherein the embedded moving image object has a transparent background that overlaps with at least one other object displayed on the e-book page.

23. A computer readable storage medium or media according to claim 22, wherein the at least one other object includes a text block.

24. A computer readable storage medium or media according to claim 23, wherein the transparent background of the embedded moving image object overlaps with a non-transparent portion of the text block.

25. A computer readable storage medium or media according to claim 22, wherein the at least one other object includes another embedded moving image object.

26. A computer readable storage medium or media according to claim 25, wherein the transparent background of the embedded moving image object overlaps with a non-transparent portion of the another embedded moving image object.

27. A computer readable storage medium or media according to claim 25, wherein the transparent background of the embedded moving image object overlaps with a transparent background of the another embedded moving image object.

28. A computer readable storage medium or media according to claim 18, wherein the machine readable instructions cause the processor to animate the moving image object in place in the e-book page by causing the image object to appear to spin in place in response to the multi-touch user input.

29. A computer readable storage medium or media according to claim 28, wherein the machine readable instructions cause the image object to spin at a decreasing rate for a period of time after the occurrence of the multi-touch user input until the image object comes to rest.

30. A computer readable storage medium or media according to claim 29, wherein the period of time or an initial rate of spin of the image object is determined by a characteristic of the multi-touch user input.

31. A computer readable storage medium or media according to claim 28, wherein the machine readable instructions cause the image object to come to rest at a predefined graphical orientation.

32. A computer readable storage medium or media according to claim 18, wherein the machine readable instructions animate the moving image object in place in the e-book page by causing the image object to appear to track a movement of a user based on one or more characteristics of the multi-touch user input.

32. A computer readable storage medium or media according to claim 18, wherein the e-book page includes multiple embedded moving image objects and wherein the machine readable instructions detect which of the multiple moving image objects to animate based on the multi-touch user input, by detecting which of the multiple moving image objects has a center point closest to one of the touches of the multi-touch user input.

33. A method, comprising:
transmitting, via a communication network, machine readable instructions to a computing device having a display, a multi-touch touchscreen associated with the display, and a processor coupled to the display and the touchscreen;
wherein the transmitted machine readable instructions, when executed by the processor of the computing device, cause the processor to:
cause an e-book page of an e-book to be displayed on the display, wherein the e-book page includes an embedded moving image object; and
cause the moving image object to be animated in place in the e-book page in response to a multi-touch user input received via the multi-touch touchscreen, wherein the multi-touch user input corresponds to a user input command to animate the moving image object.

34. A method according to claim 33, wherein the computing device is an e-book reader.

35. A method according to claim 33, further comprising transmitting the e-book to the computing device via the communications network.

36. A method according to claim 35, wherein the transmitted machine readable instructions and the transmitted e-book are transmitted as an integrated application.

37. A method according to claim 33, wherein the transmitted machine readable instructions animate the moving image object in place in the e-book page by causing the image object to appear to spin in place in response to the multi-touch user input.

38. The method according to claim 37, wherein the transmitted machine readable instructions further animate the moving image object in place in the e-book page by causing the image object to spin at a decreasing rate for a period of time after the occurrence of the multi-touch user input until the image object comes to rest.

39. The method according to claim 33, wherein the transmitted machine readable instructions animate the moving image object in place in the e-book page by causing the image object to appear to track a movement of a user based on one or more characteristics of the multi-touch user input.

40. The method according to claim 33, wherein the e-book page includes multiple embedded moving image objects and wherein the transmitted machine readable instructions detect which of the multiple moving image objects to animate based on the multi-touch user input, including detecting which of the multiple moving image objects has a center point closest to one of the touches of the multi-touch user input.
